(19) United States
(12) Patent Application Publication
(10) Pub. No.: US 2019/0354936 A1
(43) Pub. Date: Nov. 21, 2019

(54) AUTOMATIC CHALLENGE FORMATION SYSTEM

(71) Applicant: International Business Machines Corporation, Armonk, NY (US)

(72) Inventors: Lisa Seacat DELUCA, Baltimore, MD (US); Clifford A. PICKOVER, YORKTOWN HEIGHTS, NY (US)

(21) Appl. No.: 15/982,659

(22) Filed: May 17, 2018

(51) Int. Cl. G06Q 10/10; A63B 24/00; A63B 71/06; G09B 5/02

(52) U.S. Cl. CPC G06Q 10/1093; A63B 24/0062; A63B 2225/50; G09B 5/02; A63B 2220/17; A63B 71/0616

(57) ABSTRACT

An automatic challenge formation system receives a request for a new challenge for a user from a client computing device of the user, which automatically sent the request upon determining that the user not joined a challenge for a preset time limit. In response to receiving the request, the system creates the new challenge with a set of challenge characteristics, determined based on user data for the user. The system determines a list of potential participants using participant characteristics for each potential participant on the list. The system selects a set of participants from the list based on a correlation between the participant characteristics and the challenge characteristics. The system sends an invitation to a client computing device of each participant in the set of participants to join the new challenge. For each participant who accepted the invitation, the system tracks the activities of the user and each participant.

### BACKGROUND

Many people enjoy, learn, or perform better with respect to a goal or task when competing with others. For this reason, many participate in fitness and other types of challenges with others. Platforms exist for creating a challenge, however, these challenges must be created manually by a user. They require the user to manually set the characteristics of the challenge, invite a set of individuals to participate, and start the challenge on a given day. Beyond the name and a brief profile of the people the user has access to view, the user has little information about how the set of individuals within these challenges will personalize challenge the user. Unless the user manually performs these steps, the user derives no benefit from the platform.

### SUMMARY

Disclosed herein is a method for automatic challenge formation, and a computer program product and system as specified in the independent claims. Embodiments of the present invention are given in the dependent claims. Embodiments of the present invention can be freely combined with each other if they are not mutually exclusive.

According to an embodiment of the present invention, an automatic challenge formation system receives a request for a new challenge for a user from a client computing device of the user. The client computing device automatically sends the request upon determining that the user has not joined a challenge for a preset time limit. In response to receiving the request, the automatic challenge formation system creates the new challenge with a set of challenge characteristics. The set of challenge characteristics are determined based on user data for the user. The automatic challenge formation system determines a list of potential participants using participant characteristics for each potential participant on the list. The automatic challenge formation system selects a set of participants from the list based on a correlation between participant characteristics for each potential participant on the list and the challenge characteristics. The automatic challenge formation system sends an invitation to a client computing device of each participant in the set of participants to join the new challenge. For each participant who accepted the invitation, the automatic challenge formation system tracks the activities of the user and each participant.

### BRIEF DESCRIPTION OF THE DRAWINGS

FIG. 1 illustrates a computing environment for embodiments of the present invention.

FIG. 2 illustrates a method for automatic challenge formation according to exemplary embodiments of the present invention.

FIG. 3 illustrates an example graphical display of challenge results according to exemplary embodiments of the present invention.

FIG. 4 illustrates a computer system, one or more of which may implement the and is automatic challenge formation system and the client computing devices, according to embodiments of the present invention.

### DETAILED DESCRIPTION

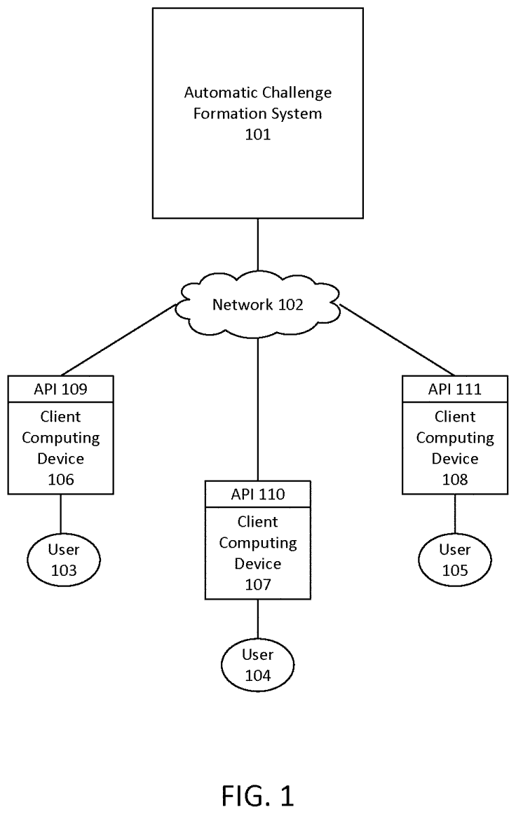

FIG. 1 illustrates a computing environment for embodiments of the present invention. The computing environment includes an automatic challenge formation system 101 coupled to a plurality of client computing devices 106-108 via a network 102. Users 103-105, via corresponding client computing devices 106-108, access a challenge service provided by the automatic challenge formation system 101 through an application programming interface (API) 109-111 at the corresponding client computing devices 106-108. When the users 103-105 are participating in a challenge, the automatic challenge formation system 101 is able to track the users' activities, as captured by the client computing devices 106-108, via the API's 109-111. The client computing devices 106-108 may include wearable or portable devices. The network 102 may be the Internet, and the client computing devices 106-108 may be configured to share data over the network 109 as Internet of Things (IoT) devices.

People often enjoy, learn, or perform better with respect to a goal or task when they are competing with others or participant in an activity as a group. For example, when people compare the number of steps they walk in a day, they can motivate each other to meet or exceed their goals. The embodiments of the present invention automatically, without user intervention, creates challenges for a user when the user has not joined a challenge within a preset time limit, and selects participants to invite to the challenge such that the user is motivated to meet or exceed the goals of the challenge.

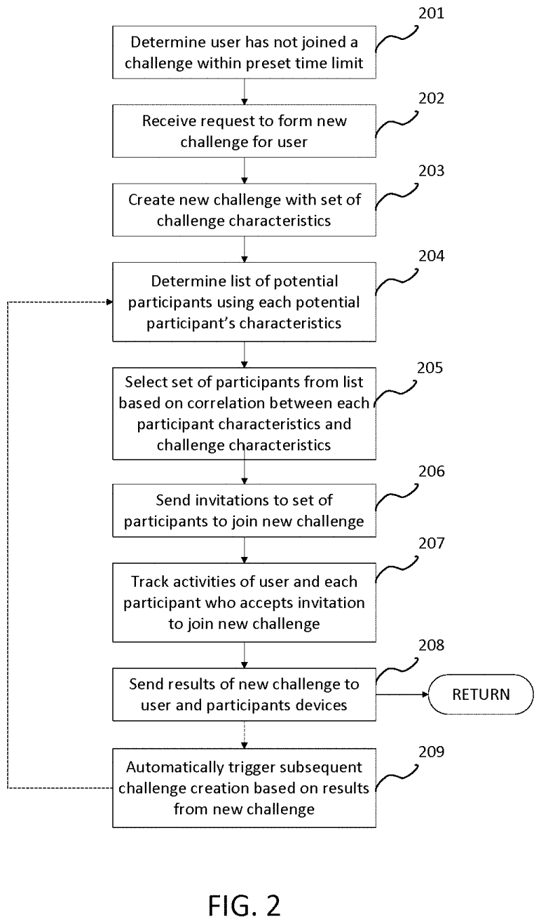

FIG. 2 illustrates a method for automatic challenge formation according to exemplary embodiments of the present invention. In an exemplary embodiment, the user 103 configures a time limit, such that, when the client computing device 106 determines that the user 103 has not joined a challenge within this preset time limit (201), this automatically (without user intervention) triggers the sending of a request to the automatic challenge formation system 101 to create a new challenge customized for the user 103. For example, the user 103 may configure the challenge service to create a challenge if the user 103 has not joined a challenge for at least two weeks. Upon receiving the request to create the new challenge for the user 103 (202), the automatic challenge formation system 101 automatically, without user intervention, create the new challenge with a set of challenge characteristics (203). The challenge characteristics may include any combination of, but is limited to: the activities for the new challenge (physical activity, weight loss, food and diet, sports, book club, educational achievement, cooking, music, etc.); a goal of the user (number of steps, weight lost, calories, reading, etc.); a length of time; a maximum number of users to participate in the new challenge; a useful size of the user pool for the new challenge; the results to be tracked; demographics of the users; threshold skills of the users; whether the users are confined to particular group or open to the public; and histories of the users (e.g., whether a user has completed a challenge in the past and performed at what level). The challenge characteristics may be based on user data, which includes any combination of, but are not limited to: a user profile; a user context (such as whether the user 103 is at work or home); a calendar of the user 103 (such as whether the user 103 is currently traveling or on vacation which may result in less activity, a current time of year, etc.); the cognitive state of the user 103 (such as the mood of the user 103); and the skill level of the user 103 in various activities. The user 103 may give the automatic challenge formation system 101 permission to access the user's social media data, calendar, messages, etc., which the automatic challenge formation system 101 may mine to obtain the user data. Using the user data, the automatic challenge formation system 101 creates the new challenge customized for the user 103.

Once the new challenge is created, the automatic challenge formation system 101 determines a list of potential participants based on each potential participant's characteristics (204). For example, the participant characteristics may include any combination of, but are not limited to: the participant profile; skill level of the participant; participant's cohort; the cognitive state of the participant; the mood of the participant; a prior result of the potential participant (e.g. if the potential participant's result in a previous challenge is significantly lower than other participants, then this participant will unlikely challenge the other participants in the previous challenge and the potential participant may be placed on the list until results improves); a historical skill level of the potential participant based on the set of challenge characteristics (e.g. the skill level of the potential participant is significantly higher than other participants and thus may discourage other participants performance due to too large a gap in skill level); and the availability of the potential participant for a particular time interval. Segments of social networks for the participants may be considered based partly on a measure of network centrality. For example, potential participants with a certain measure of centrality may be desirable since their influence suggests an ability to spread information about the challenge in a useful way. Optionally, artificial intelligence agents may be configured and considered as a potential participant. An avatar representing a fictional character, a celebrity, or other prominent individuals, against whom the user 103 may be interested in competing, may be considered a potential participant.

The automatic challenge formation system 101 selects a set of participants (e.g. users 104-105) from the list of potential participants based the correlation between each participant's characteristics and the challenge characteristics (205). By creating the new challenge with challenge characteristics customized for the user 103, and correlating the challenge characteristics with each participant's characteristics, the participants predicted to have challenge results similar, e.g. within a predefined delta, to the user 103 are selected. These participants will most likely motivate the user 103 to perform during the new challenge. In selecting the set of participants, the list of potential participants may be ranked, and the automatic challenge formation system 101 may select the top X number on the ranked list, where X is the maximum number of participants for the new challenge. Weights may be given to certain characteristics, for example, greater weight may be given to shorter relationship distances between a participant and the user 103, as competing with those in a close relationship with the user 103 will provide greater motivation for the user 103 to meet the goals of the new challenge. The ranking of a participant who is within the user's 103 family, close circle of friends, social network, or co-workers within the same department would be higher than a participant who is not. The cognitive state of the potential participant may be considered, e.g., a potential participant with a heavy load of meetings during the length of time of the challenge may the ranked lower because he or she may be less likely to join the challenge. The nature of the influence of a potential participant on the user 103 may also be considered. For example, the automatic challenge formation system 101 may strive to identify a set of potential participants who provide a certain mixture of cooperation and competition with the user 103.

Once the set of participants are selected, the automatic challenge formation system 101 sends invitations to the selected set of participants to join the new challenge (206). The client computing devices 106-108 of the user 103 and each participant who accepts the invitation sends their activities to the automatic challenge formation system 101 via the API's 109-111, as defined in the challenge characteristics. The automatic challenge formation system 101 tracks activities of the user 103 and the participants (207) during the new challenge. The tracking may be fully automated or triggered by a participant. Real-time results of the new challenge may be sent to the client computing devices 106-108 where they may be displayed (208).

The automatic challenge formation system 101 may further be configured to automatically, without user intervention, create a subsequent challenge based on the results of new challenge (209). For example, the new challenge may involve ten participants. Upon the completion of the new challenge, a subsequent challenge may be created by the automatic challenge formation system 101 for the participants with the top four results. In an exemplary embodiment, the automatic challenge formation system 101 learns from the results of each participant during the new challenge and compares these results with the user's 103 results. In one exemplary embodiment, when the difference between the results of a specific participant and the user's results are beyond a configured threshold, this specific participant is unlikely to motivate the user 103 to perform in the subsequent challenge, and thus may not be invited to participate in the subsequent challenge. In another exemplary embodiment, the automatic challenge formation system 101 determines that the user data has changed since the new challenge was created. In response, the automatic challenge formation system 101 creates the subsequent challenge using the updated user data. In another exemplary embodiment, the automatic challenge formation system 101 creates the subsequent challenge for a different user 104 or 105, using the results from the new challenge created for user 103 to create the set of subsequent challenge characteristics and/or to select the set of participants to invite to join the subsequent challenge.

Optionally, the formation of a new challenge may be based on a factor other than time. For example, the automatic challenge formation system 101 may include an image-recognition system that can automatically identify a specific product, such as an exercise machine, posted on social media by the user 103. Recognition of the specific product may trigger the automatic challenge formation system 101 to create a new challenge customized for the user 103 with challenge characteristics associated with the specific product.

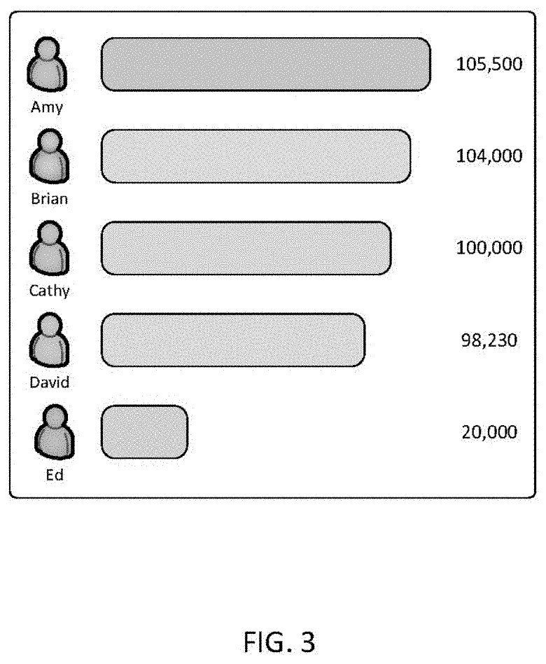

With reference to FIG. 2, consider the following example. Assume that it is Monday morning and Amy has joined a fitness challenge for several weeks (201). This triggers Amy's device to send a request to the automatic challenge formation system 101 to create a new challenge for Amy. The automatic challenge formation system 101 receives the request (202), and in response, creates Amy's new challenge with a set of challenge characteristics (203). In determining the challenge characteristics, the automatic challenge formation system 101 mines Amy's calendar and determines that Amy has a slow week in terms of meeting and her evenings are active. The automatic challenge formation system 101 determines that Amy has a volleyball game scheduled for Thursday evening and will have a week that is more active than normal. The automatic challenge formation system 101 also mines Amy's activity history and determines that Amy typically meets a 90,000 steps per week goal. The automatic challenge formation system 101 uses this data for Amy in configuring the challenge characteristics for Amy's challenge. The automatic challenge formation system 101 identifies Amy's circle of friends as potential participants for Amy's challenge, and gathers the characteristics of each of her friends (204). The automatic challenge formation system 101, based on the correlation between her friends' characteristics and Amy's challenge characteristics, determines that four of her friends will likely push Amy to go above her 90,000 steps per week goal (205). The automatic challenge formation system 101 sends invitations to these four friends to join Amy's challenge (206). Assume that all four of her friends accept the invitations. During the challenge, Amy's and her friends' devices collect and send activity data to the automatic challenge formation system 101. The automatic challenge formation system 101 tracks these activities (207), and the results of the challenge are sent to Amy and her friends' respective devices (208). FIG. 3 illustrates an example graphic display of the results of the challenge. Assume that in this example, Amy and three of her friends (Brain, Cathy, and David) exceed the 90,000 steps per week goal of the challenge, but the 4^{th} friend (Ed) only logged 20,000 steps per week. Based on these results, when the automatic challenge formation system 101 automatically creates a subsequent challenge for Amy (209). However, the fourth friend (Ed) is not included in the set of participants to receive invitations because this friend is unlikely to motivate Amy based on the results of Amy's challenge.

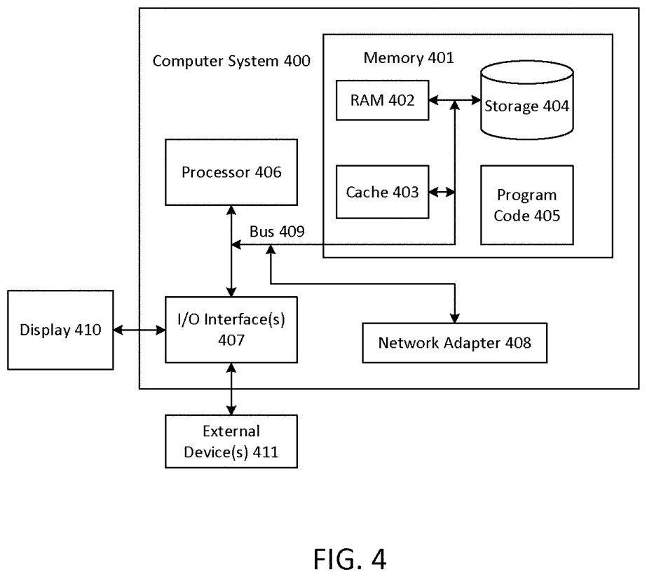

FIG. 4 illustrates a computer system, one or more of which may implement the and is automatic challenge formation system 401 and the client computing devices 406-408, according to embodiments of the present invention. The computer system 400 is operationally coupled to a processor or processing units 406, a memory 401, and a bus 409 that couples various system components, including the memory 401 to the processor 406. The bus 409 represents one or more of any of several types of bus structure, including a memory bus or memory controller, a peripheral bus, an accelerated graphics port, and a processor or local bus using any of a variety of bus architectures. The memory 401 may include computer readable media in the form of volatile memory, such as random access memory (RAM) 402 or cache memory 403, or non-volatile storage media 404. The memory 401 may include at least one program product having a set of at least one program code module 405 that are configured to carry out the functions of embodiment of the present invention when executed by the processor 406. The computer system 400 may also communicate with one or more external devices 411, such as a display 410, via I/O interfaces 407. The computer system 400 may communicate with one or more networks via network adapter 408.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor; and
a computer readable storage medium having program instructions embodied therewith, the program instructions executable by the processor to cause the processor to:
receive a request for a new challenge for a user from a client computing device of the user, the sending of the request by the client computing device being automatically triggered by the user having not joined a challenge for a preset time limit;
in response to receiving the request, create the new challenge with a set of challenge characteristics, the set of challenge characteristics determined based on user data for the user;
determine a list of potential participants using participant characteristics for each potential participant on the list of potential participants;
select a set of participants from the list of potential participants based on a correlation between participant characteristics for each potential participant on the list of potential participants and the challenge characteristics;
send an invitation to a client computing device of each participant in the set of participants to join the new challenge; and
track activities of the user and each participant in the set of participants who accepts the invitation to join the new challenge.

2. The system of claim 1, wherein the set of challenge characteristics are selected from a group consisting of: activities for the new challenge; a goal; a length of time; a maximum number of users to participate in the new challenge; the results to the tracked; demographics of the users to participate in the new challenge; threshold skills of the users to participate in the new challenge; histories of the users to participate in the new challenge.

3. The system of claim 1, wherein the user data is selected from a group consisting of: a user profile; a user context; a cognitive state of the user; a goal of the user; a calendar of the user; and a skill level of the user in one or more activities.

4. The system of claim 1, wherein the participant characteristics of a given potential participant on the list of potential participants are selected from a group consisting of: a participant profile; a skill level of the given potential participant; the given potential participant's cohort; a cognitive state of the given potential participant; a mood of the given potential participant; a prior result of the given potential participant; a historical skill level of the given potential participant based on the set of challenge characteristics; and an availability of the given potential participant for a particular time interval.

5. The system of claim 1, wherein the correlation between the participant characteristics for each potential participant on the list of potential participants and the challenge characteristics identifies the set of participants predicted to have challenge results similar to the user to perform during the new challenge.

6. The system of claim 1, wherein the processor is further caused to:
after a completion of the new challenge, automatically triggering a creation of a subsequent challenge based on results from the new challenge.

7. The system of claim 6, wherein the creating of the subsequent challenge comprises:
determine a difference between results of a given participant in the set of participants and results of the user; and
when the difference is beyond a configured threshold, not sending, to a client computing device of the given participant, an invitation to join the subsequent challenge.

8. A computer program product for automatic challenge formation, the computer program product comprising a computer readable storage medium having program instructions embodied therewith, the program instructions executable by the processor to cause the processor to:
receive a request for a new challenge for a user from a client computing device of the user, the sending of the request by the client computing device being automatically triggered by the user having not joined a challenge for a preset time limit;
in response to receiving the request, create the new challenge with a set of challenge characteristics, the set of challenge characteristics determined based on user data for the user;
determine a list of potential participants using participant characteristics for each potential participant on the list of potential participants;
select a set of participants from the list of potential participants based on a correlation between participant characteristics for each potential participant on the list of potential participants and the challenge characteristics;
send an invitation to a client computing device of each participant in the set of participants to join the new challenge; and
track activities of the user and each participant in the set of participants who accepts the invitation to join the new challenge.

9. The computer program product of claim 8, wherein the set of challenge characteristics are selected from a group consisting of: activities for the new challenge; a goal; a length of time; a maximum number of users to participate in the new challenge; the results to the tracked; demographics of the users to participate in the new challenge; threshold skills of the users to participate in the new challenge; histories of the users to participate in the new challenge.

10. The computer program product of claim 8, wherein the user data is selected from a group consisting of: a user profile; a user context; a cognitive state of the user; a goal of the user; a calendar of the user; and a skill level of the user in one or more activities.

11. The computer program product of claim 8, wherein the participant characteristics of a given potential participant on the list of potential participants are selected from a group consisting of: a participant profile; a skill level of the given potential participant; the given potential participant's cohort; a cognitive state of the given potential participant; a mood of the given potential participant; a prior result of the given potential participant; a historical skill level of the given participant based on the set of challenge characteristics; and an availability of the given potential participant for a particular time interval.

12. The computer program product of claim 8, wherein the correlation between the participant characteristics for each potential participant on the list of potential participants and the challenge characteristics identifies the set of participants predicted to have challenge results similar to the user to perform during the new challenge.

13. The computer program product of claim 8, wherein the processor is further caused to:
after a completion of the new challenge, automatically triggering a creation of a subsequent challenge based on results from the new challenge.

14. The computer program product of claim 13, wherein the creating of the subsequent challenge comprises:
determine a difference between results of a given participant in the set of participants and results of the user; and
when the difference is beyond a configured threshold, not sending, to a client computing device of the given participant, an invitation to join the subsequent challenge.

15. A method for automatically challenge formation, comprising:
receiving a request for a new challenge for a user, by an automatic challenge formation system from a client computing device of the user, the sending of the request by the client computing device being automatically triggered by the user having not joined a challenge for a preset time limit;
in response to receiving the request, creating, by the automatic challenge formation system, the new challenge with a set of challenge characteristics, the set of challenge characteristics determined based on user data for the user;
determining, by the automatic challenge formation system, a list of potential participants using participant characteristics for each potential participant on the list of potential participants;
selecting, by the automatic challenge formation system, a set of participants from the list of potential participants based on a correlation between participant characteristics for each potential participant on the list of potential participants and the challenge characteristics;
sending, by the automatic challenge formation system, an invitation to a client computing device of each participant in the set of participants to join the new challenge; and
tracking, by the automatic challenge formation system, activities of the user and each participant in the set of participants who accepts the invitation to join the new challenge.

16. The method of claim 15, wherein the set of challenge characteristics are selected from a group consisting of: activities for the new challenge; a goal; a length of time; a maximum number of users to participate in the new challenge; the results to the tracked; demographics of the users to participate in the new challenge; threshold skills of the users to participate in the new challenge; histories of the users to participate in the new challenge.

17. The method of claim 15, wherein the user data is selected from a group consisting of: a user profile; a user context; a cognitive state of the user; a goal of the user; a calendar of the user; and a skill level of the user in one or more activities.

18. The method of claim 15, wherein the participant characteristics of a given potential participant on the list of potential participants are selected from a group consisting of: a participant profile; a skill level of the given potential participant; the given potential participant's cohort; a cognitive state of the given potential participant; a mood of the given potential participant; a prior result of the given potential participant; a historical skill level of the given potential participant based on the set of challenge characteristics; and an availability of the given potential participant for a particular time interval.

19. The method of claim 15, wherein the correlation between the participant characteristics for each potential participant on the list of potential participants and the challenge characteristics identifies the set of participants predicted to have challenge results similar to the user to perform during the new challenge.

20. The method of claim 15, further comprising:
after a completion of the new challenge, automatically triggering, by the automatic challenge formation system, a creation of a subsequent challenge based on results from the new challenge.
